(19) United States
(12) Patent Application Publication
(10) Pub. No.: US 2025/0226654 A1
(43) Pub. Date: Jul. 10, 2025

(54) RESTORATION DECISION-MAKING ASSISTANCE APPARATUS AND RESTORATION DECISION-MAKING ASSISTANCE METHOD

(71) Applicant: Hitachi, Ltd., Tokyo (JP)

(72) Inventors: Masashi YAMAMOTO, Tokyo (JP); Tetsushi ONO, Tokyo (JP); Osamu TOMOBE, Tokyo (JP); Tsutomu KAWAMURA, Tokyo (JP)

(21) Appl. No.: 18/699,586

(22) PCT Filed: Oct. 6, 2022
(86) PCT No.: PCT/JP2022/037359

§ 371 Date: Apr. 8, 2024

(30) Foreign Application Priority Data
Oct. 26, 2021 (JP) 2021-174586

(51) Int. Cl. H02J 3/00; G06Q 10/0637; G06Q 50/06

(52) U.S. Cl. CPC H02J 3/0012; G06Q 10/0637; G06Q 50/06

(57) ABSTRACT

A restoration decision-making assistance apparatus and method are capable of restoring customers of a power outage by planning an isolated operation at the time of power outage restoration of a power distribution system and preparing a restoration work plan in consideration of the plan. A power system section, disconnected due to a power system accident, is connected to a power system again. A planning unit defines a switch section divided by adjacent switches for the disconnected section, and prepares an isolated operation plan with at least a switch section which includes a distributed power source therein or in which a power source vehicle is arranged as an isolated operation section. An isolated operation planning unit prepares an operation plan with a switch section in which a system accident is present as an isolated operation section and a restoration work plan is prepared for the isolated operation section.

### TECHNICAL FIELD

The present invention relates to a restoration decision-making assistance apparatus and a restoration decision-making assistance method for assisting restoration decision-making by preparing a restoration work plan in consideration of an isolated operation plan regarding a power system operated by a system operator or the like.

### BACKGROUND ART

In recent years, the introduction of a distributed power source such as a renewable energy power source into a power system has been promoted.

On the other hand, large-scale disasters such as typhoons and floods tend to increase, and cases of large-scale power outage and restoration prolongation due to a trunk system accident and a multiple accident in a power distribution system associated with the increase in the large-scale disasters become apparent. Power infrastructures are required to cope with these power supply hindrances. In the future, a new power system operation is required to achieve wide and early power outage restoration and stable power supply thereafter while maximally utilizing the distributed power source interconnected to the power system.

In particular, among power infrastructures, in a power distribution system, the introduction of distributed power sources including solar power generation has been remarkably advanced, and isolated operation in an emergency has been studied. On the other hand, in restoration work such as an accident and facility damage, it is expected that a problem arises in that a plan is prepared without considering the influence of power restoration due to the isolated operation, and efficient restoration work cannot be performed. For this reason, there is a need to expand consumers who are restored from power outages to the maximum as soon as possible in consideration of isolated operations in a power distribution system in case of emergency.

As a background art of the present technical field, there is an invention described in PTL 1. The abstract of this document describes that “The area information storage unit 120 stores the area data 10, the power distribution facility information storage unit 130 stores the power distribution facility data 20, and the commander simulation unit 141, the patrol person simulation unit 142, and the restoration person simulation unit 143 refer to the area information storage unit 120 and the power distribution facility information storage unit 130 to simulate work performed by the commander, the patrol person, and the restoration person, respectively. In addition, the restoration person simulation unit 143 simulates the movement of the restoration person to the disaster-stricken area and waiting for an instruction from the commander.”.

### CITATION LIST

### Patent Literature

PTL 1: JP 2014-2783 A

### SUMMARY OF INVENTION

### Technical Problem

According to PTL 1, it is possible to allocate a restoration target facility to a restoration work group so that restoration can be performed as soon as possible and prepare a restoration work plan. However, the capacity of the load to be power-restored by each facility restoration is not taken into consideration, and it is not possible to efficiently restore more customers from power outages. In addition, since the isolated operation is not planned, it is not possible to prepare a plan to restore the consumers in the healthy power outage area from power outage by the isolated operation, it is not possible to determine the area where the power outage is to be restored by the isolated operation, and it is not possible to make an efficient restoration plan.

Therefore, an object of the present invention is to provide a restoration decision-making assistance apparatus and a restoration decision-making assistance method capable of restoring as many customers as possible from a power outage as soon as possible by planning an isolated operation at the time of power outage restoration of a power distribution system and preparing a restoration work plan in consideration of the isolated operation plan.

### Solution to Problem

From the above, the present invention is “A restoration decision-making assistance apparatus for connecting a power system section disconnected due to a power system accident to a power system again, the restoration decision-making assistance apparatus comprising: an isolated operation planning unit configured to define a switch section divided by adjacent switches for the disconnected power system section, and to prepare an isolated operation plan with at least a switch section which includes a distributed power source therein or in which a power source vehicle is arranged as an isolated operation section; and a restoration work planning unit configured to prepare a restoration work plan for a switch section in which an accident or a damaged facility is present in the power system.”

In addition, the present invention is “A restoration decision-making assistance method that is implemented by using a computer and connects a power system section disconnected due to an accident of a power system to the power system again, the restoration decision-making assistance method comprising: defining a switch section divided by adjacent switches for the disconnected power system section, and preparing an isolated operation plan with at least a switch section having a distributed power source therein or a switch section in which a power source vehicle is arranged as an isolated operation section; and preparing a restoration work plan for a switch section in which an accident or damaged facility is present in the power system.”

### Advantageous Effects of Invention

According to the present invention, it is possible to formulate a plan for widely restoring a power outage area in a power system as soon as possible.

### BRIEF DESCRIPTION OF DRAWINGS

FIG. 1 is a block diagram showing a restoration decision-making assistance apparatus according to an embodiment of the present invention.

FIG. 2 is a diagram showing a configuration example of a power distribution system L to which the present invention can be applied.

FIG. 3 is a diagram showing an example of system information D1 among various types of information held in a large-capacity storage unit DB.

FIG. 4 is a diagram showing an example of facility damage information D2 among various types of information held in a large-capacity storage unit DB.

FIG. 5 is a diagram showing an example of power outage information D3 among various types of information held in a large-capacity storage unit DB.

FIG. 6 is a diagram showing an example of essential load information D4 among various types of information held in a large-capacity storage unit DB.

FIG. 7 is a diagram showing an example of map information D5 among various types of information held in a large-capacity storage unit DB.

FIG. 8 is a diagram showing an example of resource information D6 among various types of information held in a large-capacity storage unit DB.

FIG. 9 is a diagram showing an example of required work time information D8 among various types of information held in a large-capacity storage unit DB.

FIG. 10 is a flowchart showing the processing of the isolated operation planning unit 7.

FIG. 11 is a diagram showing the result of matrix creation in processing step S71 in FIG. 10.

FIG. 12 is a flowchart showing the processing of the restoration work planning unit 9.

FIG. 13 is a flowchart showing the processing of a screen output unit.

FIG. 14 is a diagram showing an example of a screen output by the screen output unit.

### DESCRIPTION OF EMBODIMENTS

Hereinafter, embodiments of the present invention will be described in detail with reference to the drawings.

### Embodiment

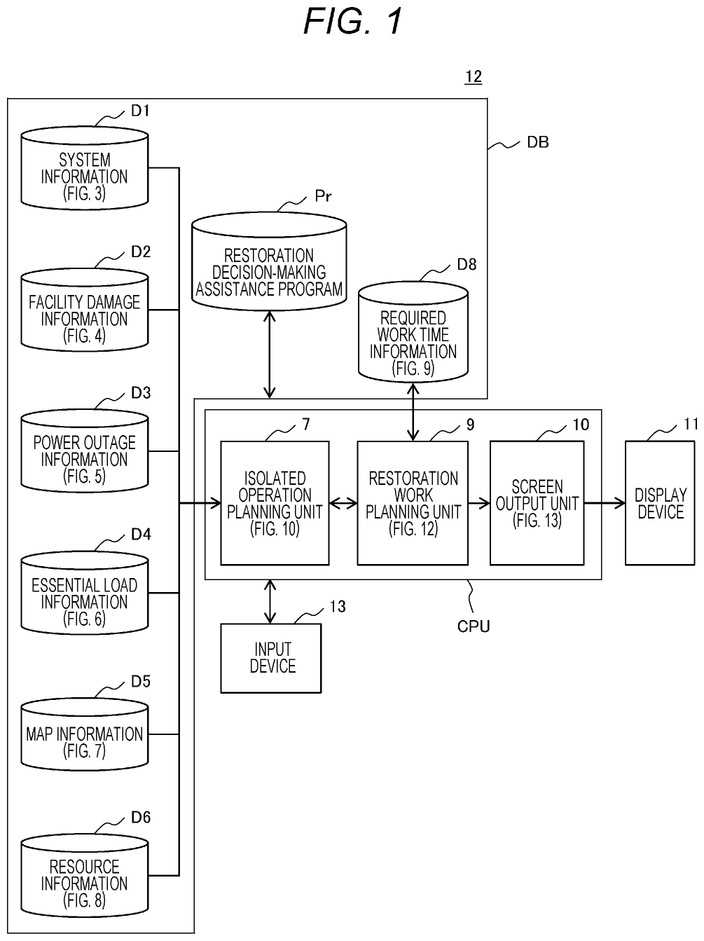

FIG. 1 is a block diagram showing a restoration decision-making assistance apparatus according to an embodiment of the present invention. The restoration decision-making assistance apparatus 12 includes a computer including a calculation unit CPU (Central Processing Unit), a RAM (Random Access Memory: not shown), and a nonvolatile large-capacity storage unit DB. It should be noted that the present invention may be implemented as a restoration decision-making assistance system in which a plurality of servers and the like cooperate, not limited to a single apparatus.

The restoration decision-making assistance apparatus 12 implemented by using a computer has functions of an isolated operation planning unit 7, a restoration planning unit 9, and a screen output unit 10 when processing contents in the calculation unit CPU are represented by processing functions, and further includes a display device 11 and an input device 13.

The restoration decision-making assistance apparatus 12 further stores system information D1, facility damage information D2, power outage information D3, essential load information D4, map information D5, resource information D6, required work time information D8, and a restoration decision-making assistance program Pr in a nonvolatile large-capacity storage unit DB.

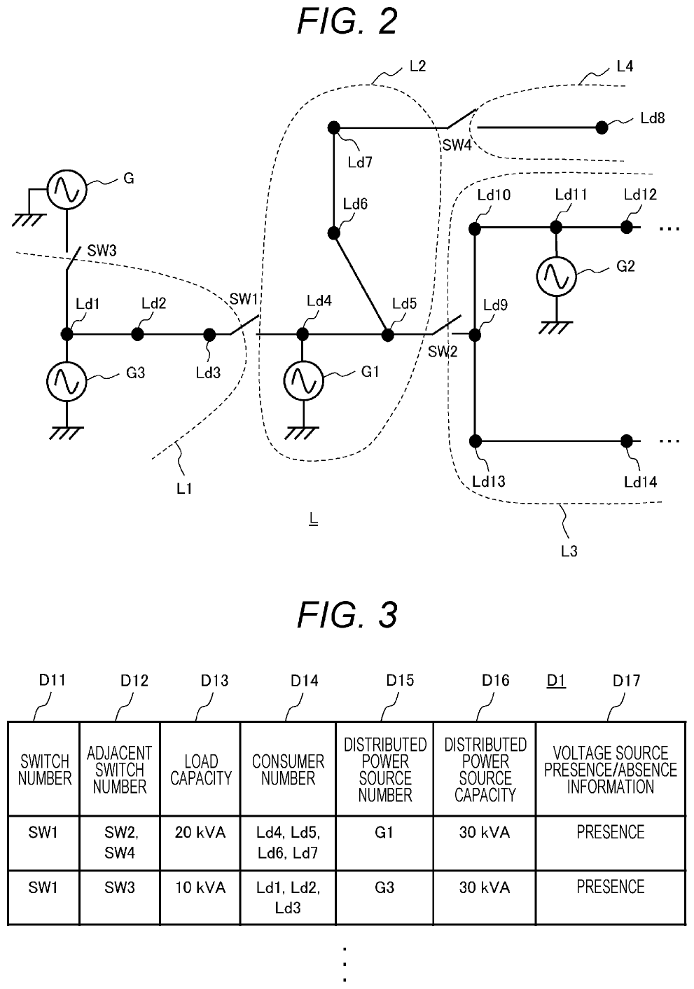

In describing specific contents of these pieces of information, a configuration example of the power distribution system L to which the present invention is applicable will be described with reference to FIG. 2. The power distribution system L includes a plurality of consumers Ld (Ld1 to Ld14), a plurality of distributed power sources G (G1 to G3), substations, and switches SW (SW1 to SW4) such as circuit breakers and switches. Each consumer is indicated by a node of a black circle and a symbol such as “Ld1” or “Ld2” adjacent thereto.

With this configuration, each consumer Ld can receive a power supply from the external power source G. For example, in a state where the normal operation is being executed, the switches SW (SW1 to SW4) such as the circuit breaker and the switch are closed and connected to the external power source G through the switch SW3, whereby power is supplied to the plurality of consumers Ld.

However, when the illustrated section is disconnected from the external power source G due to an accident in the power distribution system L, the switches SW (SW1 to SW4) are closed again after the accident is eliminated, so that restoration is performed. However, in the present invention, it is assumed how to perform the system operation in a restoration waiting period from the accident to the restoration. For example, when a large-scale power outage occurs due to an earthquake or the like, the restoration period is sequentially expanded, but the period until the restoration is assumed to be from several days to a dozen or so days, and the present invention is particularly useful when a power outage occurs for a long term.

In the restoration waiting state, all the switches SW are released, but according to this example of the power distribution system, the isolated operation section can be formed in an appropriate section. For example, since the section L1 divided by the switch SW3 and the switch SW1 includes the consumers Ld1 to Ld3, the substation, and the distributed power source G3 during this time, an isolated operation section can be formed. Similarly, since the section L2 divided by the switches SW1, SW2, and SW4 includes the consumers Ld4 to Ld7, the substation, and the distributed power source G1, it is possible to form an isolated operation section. Furthermore, since the section L3 divided by the switch SW2 includes the consumers Ld9 to Ld14, the substation, and the distributed power source G2, an isolated operation section can be formed. However, the section L4 divided by the switch SW4 includes the consumer Ld, but is not connected to the distributed power source G when the switch SW4 is released, and thus, it is not possible to form the isolated operation section. It should be noted that, in the above description, it is described that the minimum section between the adjacent switches can be the isolated operation section, but an appropriately enlarged section may be defined as the isolated operation section. In addition, in the above description, the distributed power source G is a renewable energy power source such as solar power generation or wind power generation, a cogeneration apparatus, an electric storage facility, or the like.

However, the isolated operation section described here merely describes the possibility of operation using the distributed power source G, and further checking of other requirements is required for actual operation. In the present invention, processing based also on these checking matters will be described below.

Various pieces of information held in the nonvolatile large-capacity storage unit the DB in restoration decision-making assistance apparatus 12 in FIG. 1 will be described below with reference to the example of the power distribution system Lin FIG. 2. First, an example of the system information D1 is illustrated in FIG. 3.

The system information D1 is information indicating the number D11 of each switch Sw, the number D12 of the adjacent switch Sw, the load capacity D13 in each switch section, the consumer number D14, the distributed power source number (The distributed power source is a concept including a substation and a distributed power source.) D15, the distributed power source capacity D16, and the presence or absence of a voltage source (information indicating whether there is a voltage source necessary for starting the isolated operation system in the switch section) D17 as information on each switch (switch SW) in the power distribution system L of the example in FIG. 2 managed by the restoration decision-making assistance apparatus 12. It should be noted that a section L2 is defined by the information group in the first row in FIG. 3, and a section L1 is defined by the information group in the second row.

The system information D1 shown in FIG. 3 is associated with the power distribution system L in FIG. 2 managed by the restoration decision-making assistance apparatus 12. The system information D1 indicates, for example, positions of a switch SW such as a switch, a distributed power source G, a power distribution substation, and the like, and includes, for example, switch numbers D11 and D12, a distributed power source number D15, a number identifying the power distribution substation, information on a consumer number D14 corresponding to a node, and the like. The power distribution system L managed by the restoration decision-making assistance apparatus 12 may have any configuration as long as it is associated with the system information D1, and is not limited to the configuration shown in FIG. 2. In addition, each element of the power distribution system L managed by the restoration decision-making assistance apparatus 12 is associated with position information on a map such as roads and houses indicated in the map information D4.

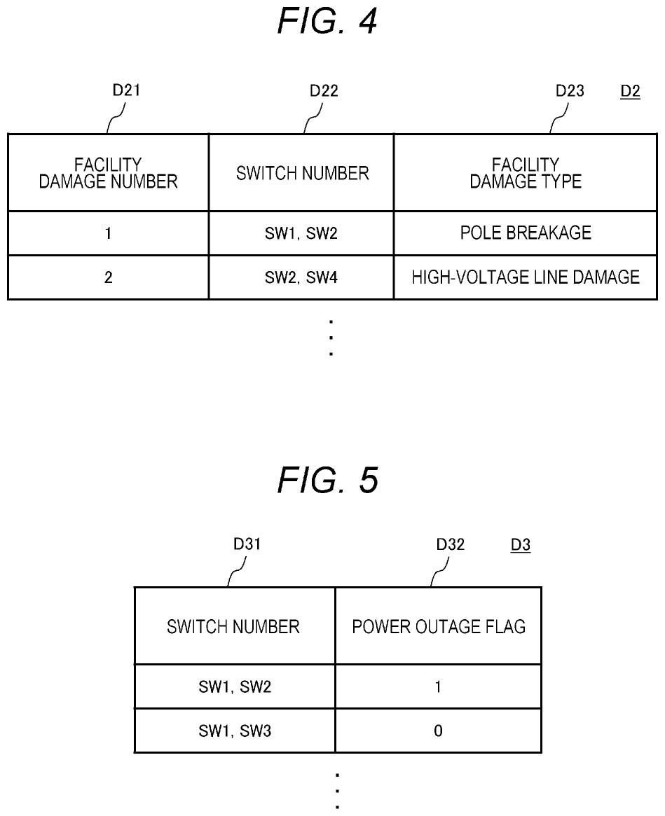

As illustrated in FIG. 4, the facility damage information D2 is information for identifying a place and a type of accident or facility damage in the power distribution system L, and here, a facility damage number D21, a switch number D22, and a facility damage type D23 are stored. The facility damage number D21 stores information on a serial number for identifying an accident or facility damage in the power distribution system L shown in FIG. 2. The switch number field D22 stores information on a switch number constituting a switch section in which an accident or facility damage corresponding to the facility damage number D21 has occurred. Here, the switch number D22 corresponds to the switch numbers D11 and D12 of the system information D1. The facility damage type field D23 stores information on a type of accident or facility damage corresponding to the facility damage number D21. The type of accident or facility damage is, for example, a pole breakage or a high-voltage line damage. The facility damage information D2 may hold a facility failure place field, and in that case, stores a detailed position of the facility failure as, for example, coordinate information associated with the power distribution system L.

It should be noted that the first row in FIG. 4 indicates that a pole breakage has occurred between the switches SW1 and SW2 of the power distribution system in FIG. 2. The second row indicates that high-voltage line damage has occurred between the switches SW2 and SW4 of the power distribution system in FIG. 2.

As illustrated in FIG. 5, the power outage information D3 is information indicating energization or a power outage state of each switch section in the power distribution system L, and includes, for example, a switch number D31 and a power outage flag D32. The switch number field D31 stores information on serial numbers identifying the switches D11 and D12 constituting each switch section of the power distribution system L shown in FIG. 2. Here, the switch number D31 corresponds to the switch numbers D11 and D12 of the system information D1. The power outage flag field D32 stores information indicating whether a power outage has occurred in each switch section. For example, 1 is stored if a power outage has occurred, and 0 is stored if no power outage has occurred.

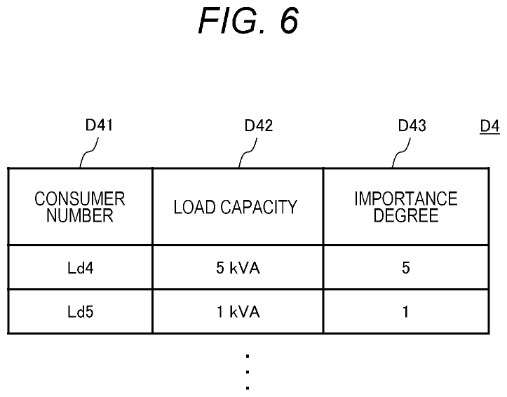

As illustrated in FIG. 6, the essential load information D4 is information indicating the consumer number D41 of each essential load such as a hospital or a shelter, the load capacity D42 of the essential load, and the importance degree D43. The consumer number field D41 stores information on a serial number for identifying an essential load such as a hospital or a shelter in the power distribution system L shown in FIG. 2. Here, the consumer number of the essential load corresponds to the consumer number of the system information D1. The load capacity field D42 information on the load capacity of the essential load. The importance degree field D43 stores information on the importance degree of an optionally set essential load. Here, for example, the numbers 1 to 5 that are evaluated to be more important as the number increases are stored. The importance degree is not limited to this as long as its form can be handled by processing in the isolated operation planning unit 7 and the restoration work planning unit 9 described below. In addition, the importance degree is not necessarily handled by the processing in the isolated operation planning unit 7 and the restoration work planning unit 9, but details will be described below in an embodiment in each processing unit.

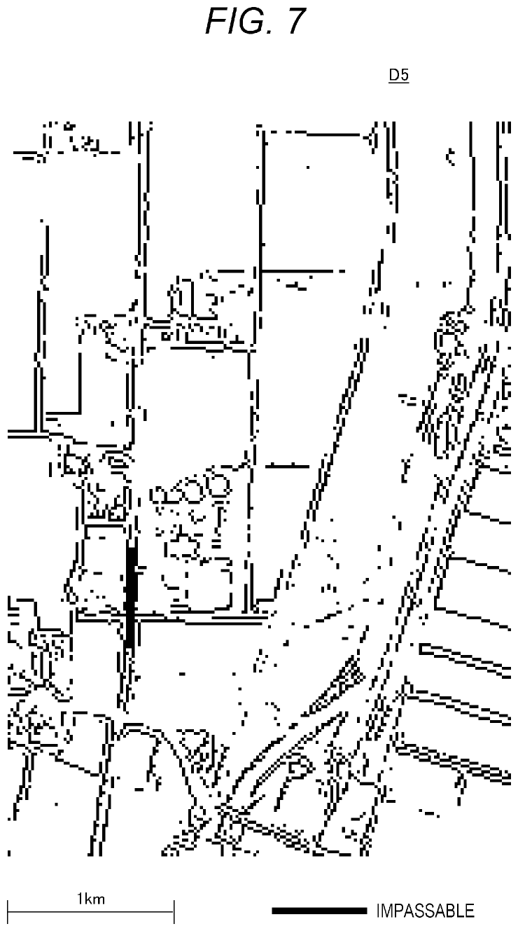

As illustrated in FIG. 7, the map information D5 is a map of an area corresponding to the power distribution system L and is information indicating a road network, an impassable road place, a house, and the like. The impassable road information is information indicating a section of an impassable road.

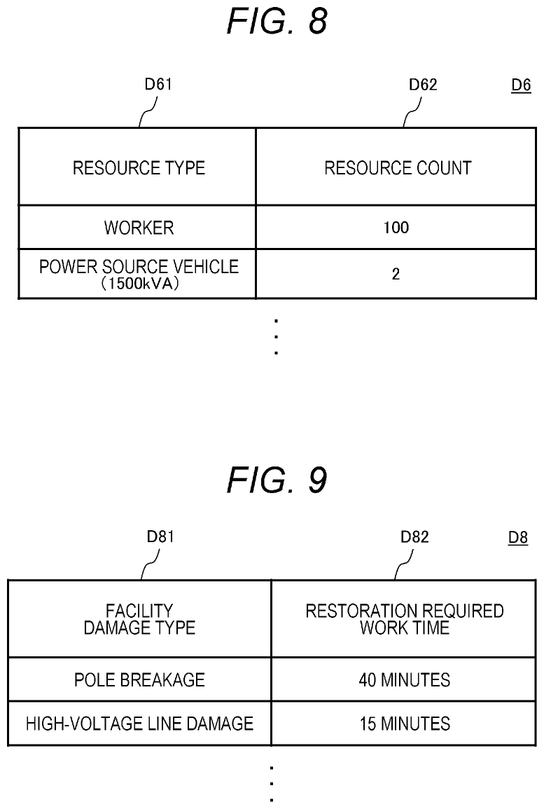

As illustrated in FIG. 8, the resource information D6 is information on the resource type D61, the resource amount D62, and the resource position of a worker, a work vehicle, or the like that can be used in the power distribution system L.

The resource type field D61 stores information such as a worker, a vehicle necessary for restoration work such as a high voltage generator vehicle (hereinafter, a power source vehicle) or a digger derrick truck, or a drone. The workers may be divided into work groups in advance depending on skills or the like. In this case, for example, work groups such as a high voltage line restoration work group and a pole breakage handling group may be stored as resource types. Here, the power source vehicle holds capacity information such as a power source vehicle (1200 kVA) and a power source vehicle (1500 kVA), and power source vehicles having different capacities are stored as different resource types. The resource count field D62 stores the number of resources.

As illustrated in FIG. 9, the required work time information D8 is information indicating the restoration required work time D82 for each facility damage type D81. The facility damage type field D81 stores information on the types of accidents and facility damage. The type of accident or facility damage is, for example, a pole breakage or a high-voltage line damage. The restoration required work time field D82 stores information on the time required for the restoration worker to restore an accident or facility damage corresponding to the facility damage type. Here, the required time is the time from the arrival of the restoration worker at the site to the completion of the restoration work and does not include the travel time. The required time can be optionally set by the user, and for example, an average required work time or the like in the past restoration work can be stored.

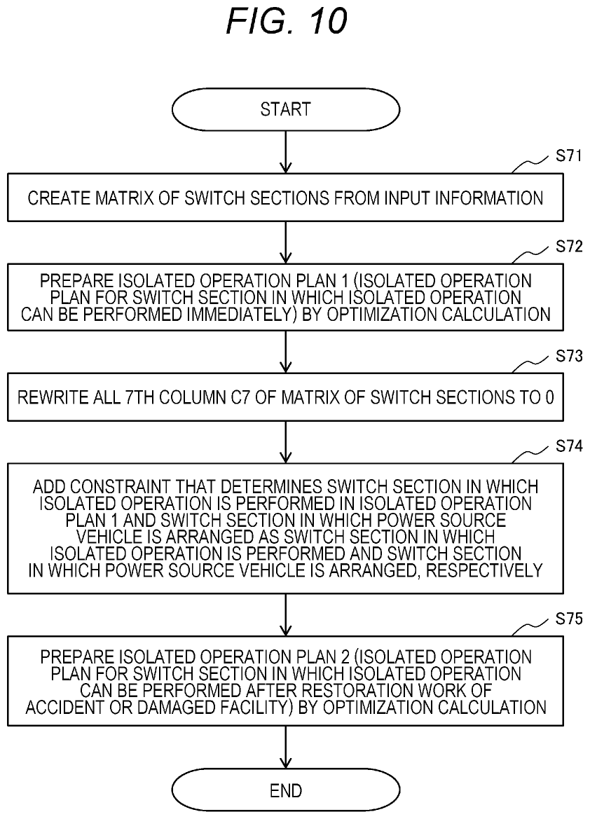

Returning to FIG. 1, various processing functions executed by the calculation unit CPU will be described. First, the isolated operation planning unit 7 is a functional unit that prepares an isolated operation plan based on the system information D1, the facility damage information D2, the power outage information D3, the map information D4, the essential load information D5, and the resource information D6, and the processing thereof will be described with reference to FIG. 10.

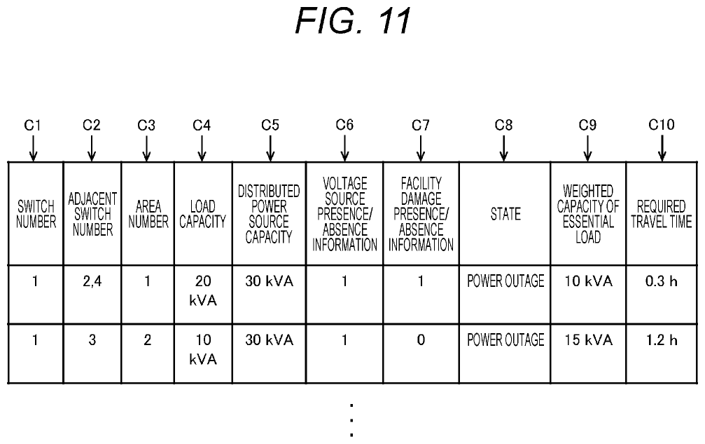

FIG. 10 is a flowchart showing the processing of the isolated operation planning unit 7. In the first processing step S71 of the flow in FIG. 10, a matrix of switch sections is created from the input information. It should be noted that in the following description, a case where the switch SW is a switch will be described. This processing is specifically performed as follows, for example. It should be noted that the result of matrix creation in processing step S71 in FIG. 10 is illustrated in FIG. 11.

When the processing is started, the isolated operation planning unit 7 extracts all the switch numbers of the switches in the power distribution system L managed by the isolated operation planning unit 7 from the system information D1, and sets the extracted switch numbers as the first column C1 of the matrix of the switch sections. Thereafter, the isolated operation planning unit 7 extracts the switch numbers of all the switches adjacent to the switches corresponding to the switch numbers in the first column from the system information D1, sets the switch numbers as the second column C2 of the matrix of the switch sections, and identifies all the switch sections. Thereafter, the isolated operation planning unit 7 assigns area numbers such as, for example, area 1 (for example, section L1) and area 2 (for example, section L2) to each switch section, and sets the area numbers as the third column C3 of the matrix of the switch sections. Through these pieces of processing, the switch number of the switch necessary for the configuration of each switch section and the adjacent switch sections, that is, the switch sections divided by the same switch can be identified in a unified manner by the area number. Thereafter, the isolated operation planning unit 7 extracts the load capacity of each switch section from the system information D1, and sets the load capacity as the fourth column C4 of the matrix of the switch sections. Thereafter, the isolated operation planning unit 7 extracts the distributed power source capacity of each switch section from the system information D1, and sets the distributed power source capacity as the fifth column C5 of the matrix of the switch sections. Thereafter, the isolated operation planning unit 7 extracts the presence or absence of the voltage source of each switch section from the system information D1, and sets the presence or absence of the voltage source as the sixth column C6 of the matrix of the switch sections. Thereafter, the isolated operation planning unit 7 identifies a switch section having an accident or facility damage from the facility damage information D2, and stores the switch section having an accident or facility damage as 1 and the switch section having no accident or facility damage as 0 in the seventh column C7 of the matrix of the switch sections. When detailed position information of an accident or facility damage is held in the facility damage information D2, coordinate information of an accident or facility damage associated with the power distribution system L may be stored in a switch section having an accident or facility damage.

Thereafter, the isolated operation planning unit 7 extracts the power outage state or the energization state of each switch section from the power outage information D3, and sets the extracted state as the eighth column C8 of the matrix of the switch sections. Thereafter, the isolated operation planning unit 7 extracts the load capacity and the importance degree of each essential load from the essential load information D4, calculates a product thereof, sums up the essential loads existing in each switch section, and sets the sum as the ninth column of the matrix of the switch sections. The importance degree can be determined in advance whether the user optionally handles the importance degree. When the importance degree is not handled, this processing is not executed, and all the ninth columns C9 of the matrix of the switch sections are set to 0. Thereafter, the isolated operation planning unit 7 calculates the shortest time required for the power source vehicle, the worker, or the like to move from the office to the closest switch position constituting each switch section as the required travel time, using the road network of the map information D5 and the impassable road information, and sets the calculated required travel time as the 10th column C10 of the matrix of the switch sections.

By the above-described series of processing in the first processing step S71 of the flow in FIG. 10, a matrix of switch sections is created. It should be noted that in the 10th column of the matrix of the switch sections, here, the required travel time is calculated by dividing the length of the shortest route from the office to the switch constituting the switch section by the average travel speed such as 30 km/h. In addition, when the shortest route from the office to the switch constituting the switch section includes an impassable road section, the average travel speed while passing through the impassable road section is reduced to, for example, 15 km/h, and the required time when detouring is taken into consideration. It is assumed that an average travel speed such as 30 km/h or 15 km/h can be set in advance, and the average travel speed is not limited thereto.

According to the matrix creation result in FIG. 11, various states in this section and problems at the time of restoration are generally organized and summarized for each area that can be the isolated operation section.

Next, in processing step S72 in FIG. 10, an isolated operation plan 1 (the isolated operation plan for the switch section in which the isolated operation can be performed immediately) is prepared by optimization calculation. It should be noted that in the case of the power distribution system L in FIG. 2, the switch section in which the isolated operation can be performed immediately is only the sections L1 and L3, and the accident state continues in the section L2, so that the isolated operation cannot be unconditionally performed. Therefore, the isolated operation planning unit 7 performs optimization calculation with the following objective function and constraint, prepares an isolated operation plan, and saves the isolated operation plan as isolated operation plan 1. Accordingly, it is possible to immediately determine the switch section in which an isolated operation can immediately be performed.

Here, the objective function in performing the optimization calculation is formulated as a problem of calculating the total sum of a product of the load capacity of the switch section in the power outage state and the power outage duration for each switch section, over all the switch sections and minimizing the total sum. Accordingly, the isolated operation plan can be prepared to minimize the power outage damage. The load capacity of each switch section is calculated by taking the sum of the fourth column C4 and the ninth column C9 of the matrix of the switch sections. Accordingly, when an essential load is considered, it is possible to prepare an isolated operation plan for preferentially restoring power according to the importance degree. The duration of the power outage state is, for example, 0 hours in the switch section in which the isolated operation is performed by the distributed power source such as the solar power generation or the system storage battery assuming that the power is immediately restored after preparing the planning, the required travel time of the power source vehicle in the switch section in which the isolated operation is performed by the power source vehicle, and 72 hours in the switch section in which the power is not restored by the isolated operation. Here, the power outage time of the switch section in which the isolated operation is performed by the distributed power source is assumed to be set in advance in consideration of the available duration of the isolated operation and the like, and is not limited to 0 hours. In addition, the power outage time of the switch section in which power is not restored by the isolated operation is also assumed to be set in advance as the maximum value of the period in which power restoration is attempted according to the present plan, and is not limited to 72 hours.

In addition, the constraint in performing the optimization calculation mainly includes the following three. The first is that the isolated operation is not performed in a switch section where there is an accident or a facility failure. Accordingly, it is possible to prevent re-power outage, electric shock damage, and the like caused by performing the isolated operation despite there being an accident or a facility failure. The presence or absence of an accident or a facility failure in the switch section is determined by performing extraction from the seventh column C7 of the matrix of the switch sections.

The second is that the isolated operation is not performed in the switch section without a voltage source unless the switch section is interconnected with the switch section with a voltage source. Accordingly, it is possible to prevent a situation in which there is no voltage source in a system in which isolated operation is scheduled and power cannot be restored. The presence or absence of the voltage source in each switch section is determined by performing extraction from the sixth column C6 of the matrix of the switch sections. In addition, regarding the interconnection of the switch sections, it is assumed that when the adjacent switch sections perform operations isolated from each other, the adjacent switch sections always operate in an interconnected manner. The adjacent switch sections are identified and determined from the second column C2 of the matrix of the switch sections.

The third is that the total sum of the load capacities in the switch section in which the isolated operation is interconnectedly performed is equal to or less than the total sum of the distributed power source capacities in the switch section. Here, when the power source vehicle is disposed in one or more sections of the switch section, the sum of the total sum of the distributed power source capacities in the switch section and the total sum of the capacities of the power source vehicles are compared with the total sum of the load capacities in the switch section. Accordingly, it is possible to prevent the re-power outage in consideration of the supply and demand matching in the isolated operation area. The load capacity and the distributed power source capacity in each switch section are extracted from the fourth column C4 and the fifth column C5 of the matrix of the switch sections, respectively. The capacity of the power source vehicle is obtained by extracting information on the capacity corresponding to the type of the power source vehicle to be disposed from the resource information D6.

It should be noted that when it is necessary to change the input in performing the optimization calculation, all the seventh column C7 of the matrix of the switch sections is rewritten to 0 in the processing step S73 in FIG. 10. Accordingly, a system state after restoration work in which all accidents and facility failures are removed is assumed.

In addition, when it is necessary to add a constraint in performing the optimization calculation, in processing step S74 in FIG. 10, the switch section in which the isolated operation is performed in the isolated operation plan 1 and the switch section in which the power source vehicle of each capacity is arranged are respectively fixed to the plan as the switch section in which the isolated operation is performed and the switch section in which the power source vehicle is arranged. Accordingly, when the system re-interconnection or the power restoration by the isolated operation is selected after the restoration work of the accident or the facility failure for the switch section in which power is not restored after the isolated operation is performed according to the isolated operation plan 1, the power restoration means can be selected so as to minimize the power outage damage.

Thereafter, in the processing step S75 in FIG. 10, the isolated operation plan preparing unit 7 changes the input and adds the constraint described below, performs the optimization calculation again, prepares the isolated operation plan after the restoration work, and saves the plan as the isolated operation plan 2 (the isolated operation plan for the switch section in which isolated operation can be performed after the restoration work of the accident or damaged facility). Accordingly, in the restoration work planning unit 8 to be described below, the isolated operation can be considered in addition to the system re-interconnection as the power restoration means after the restoration work of the accident or the damaged facility, and the efficient restoration work plan in which the power outage damage is minimized can be prepared. It should be noted that in the case of the power distribution system L in FIG. 2, the switch section in which the isolated operation can be performed after the restoration work of the accident or the damaged facility is the section L2 and the consumer Ld8, and accordingly, the isolated operation plan is formulated for all the sections.

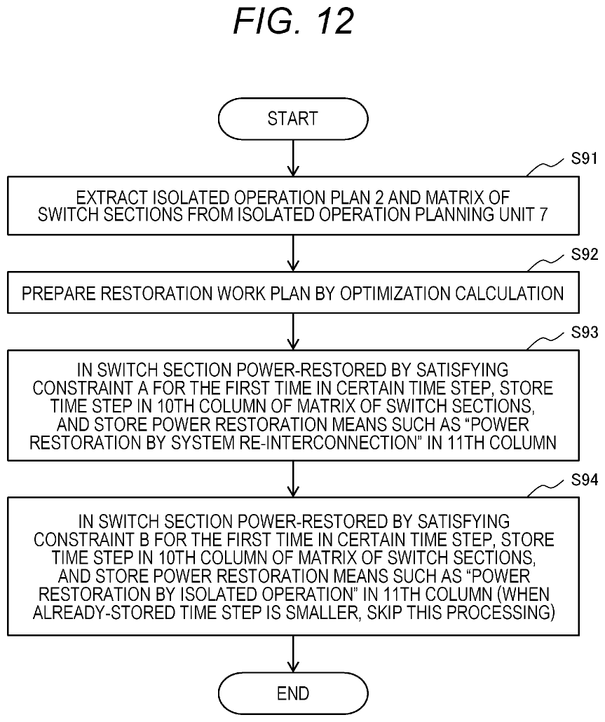

The restoration work planning unit 9 is a functional unit that prepares a restoration work plan based on the system information D1, the facility damage information D2, the power outage information D3, the map information D4, the essential load information D5, the resource information D6, the isolated operation plan received from the isolated operation planning unit 7, and the required work time information D8, and the processing thereof will be described with reference to FIG. 12.

FIG. 12 is a flowchart showing the processing of the restoration work planning unit 9. In the first processing step S91 of the flow in FIG. 12, the restoration work planning unit 9 extracts the isolated operation plan 2 and the matrix of the switch section (illustrated in FIG. 11) from the isolated operation planning unit 7.

Thereafter, in processing step S92, the restoration work planning unit 9 performs optimization calculation having the following objective function and constraint, and saves the result as a restoration work plan.

Here, the objective function in performing the optimization calculation is formulated as a problem in which a binary variable representing the state of each switch section as 0 in the case of power restoration and 1 in the case of power outage is summed and calculated in all the switch sections and for each time step, and the sum is minimized. The time step can be optionally set by the user, for example, as one minute.

In addition, the constraint in performing the optimization calculation mainly includes the following six. The first is that the same worker or workgroup can perform only one or less work or movement in one time step.

The second is that the number of time steps during which the same worker or workgroup stays in one facility-damaged place is equal to or more than the number of time steps corresponding to the required work time of the facility damage.

The type of facility damage of each facility-damaged place is extracted from the facility damage type D23 of the facility damage information D2, and the corresponding required work time is extracted from the required work time information D8.

The third is that the number of time steps at which the same worker or workgroup moves between two facility-damaged places is equal to or more than the number of time steps corresponding to the required travel time between the two places.

Here, the required travel time between the two places is calculated by extracting the length of the shortest route between the two places from the map information D5 and dividing the length by an average travel speed such as 30 km/h. In addition, when the shortest route includes an impassable road section, the average travel speed while passing through the impassable road section is reduced to, for example, 15 km/h, and the required time when detouring is made is taken into consideration. It is assumed that an average travel speed such as 30 km/h or 15 km/h can be set in advance, and the average travel speed is not limited thereto.

The fourth is that the switch section having one or more accident points is not power-restored. The fifth is that in each time step, among the switch sections from which all the accident points have been removed, the switch section adjacent to the switch section in the energized state in the eighth column C8 of the matrix of the switch sections and the switch section leading to any one of the switch sections in the energized state in the eighth column C8 of the matrix of the switch sections when following the adjacent switch sections in the energized state is set to the power restoration state (referred to as a constraint A).

The sixth is that among the switch sections having no accident points, the switch section in which the isolated operation is scheduled in the isolated operation plan 2 is set to the power restoration state (referred to as a constraint B).

It should be noted that, in executing the fifth constraint, in the processing step S93, in the switch section power-restored by satisfying the constraint A for the first time in a certain time step, the time step is stored in the 10th column C10 of the matrix of the switch sections, and a power restoration means such as “power restoration by system re-interconnection” is stored in the 11th column.

In addition, in executing the sixth constraint, in the processing step S94, in the switch section power-restored by satisfying the constraint B for the first time in a certain time step, the time step is stored in the 10th column C10 of the matrix of the switch sections, and a power restoration means such as “power restoration by isolated operation” is stored in the 11th column C11. On this occasion, when the time step satisfying the constraint A for the first time is stored in the 10th column C10 of the matrix of the switch sections, the time steps satisfying the respective constraints for the first time are compared, and the smaller time step is stored. In the 11th column of the matrix of the switch sections, the power restoration means corresponding to the constraint satisfied for the first time in the time step stored in the 10th column C10 is stored.

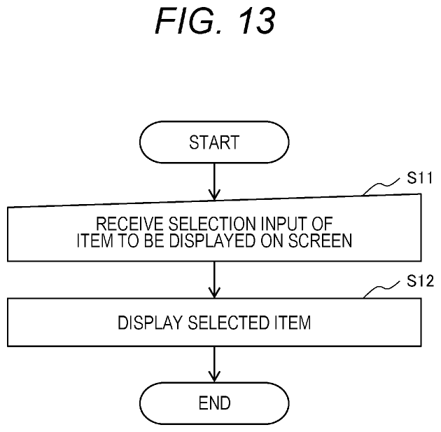

The screen output unit 10 is a functional unit that selects and displays contents to be displayed on the display device 11, and processing thereof will be described with reference to FIG. 13. FIG. 13 is a flowchart showing an example of the processing of the screen output unit 10. It should be noted that the display device 11 includes, for example, a liquid crystal panel, an organic electro luminescence (EL) panel, or the like, and displays display contents or the like selected by the operator.

In the processing of the screen output unit 10 in FIG. 13, the selection input of an item to be displayed on the screen is received in processing step S11, and the selected item is displayed in processing step S12.

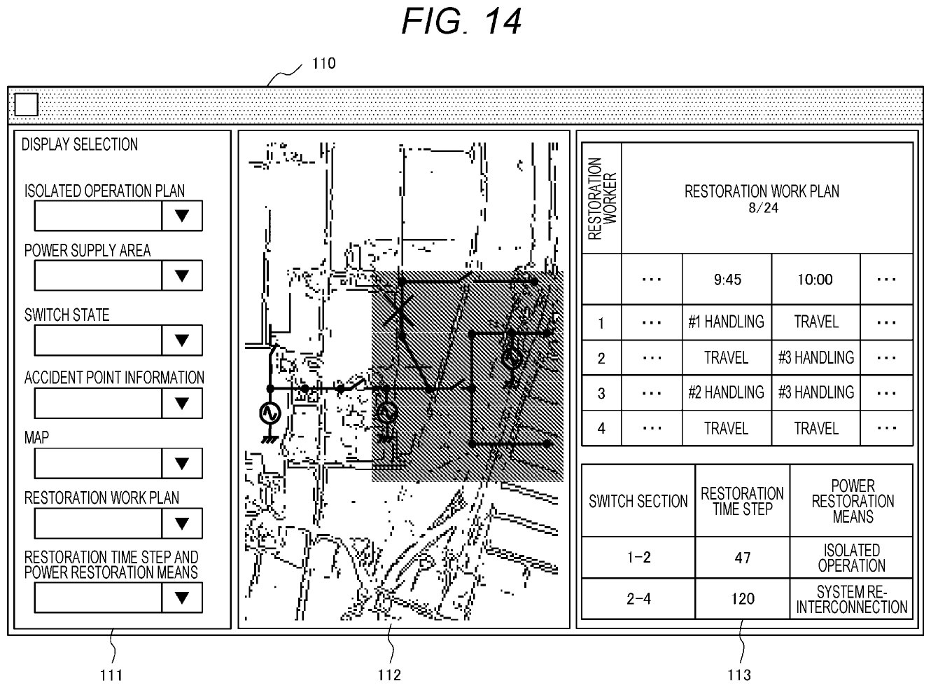

Next, a configuration example of the screen 110 in FIG. 14 will be described. The screen includes a plurality of panes 111, 112, and 113 which are screen-split small areas. On the screen 110 displayed on the display device 11, display contents selected by the screen output unit 10 are displayed.

The display content selection pane 111 is a display for the operator to operate and select the display contents to be selected and processed by the screen output unit 10. Accordingly, the display contents selected in the display content selection pane 111 are displayed in another pane. As selectable factors, an isolated operation plan, a power supply area, a switch state, accident point information, a map, a restoration work plan, a restoration time step, a power restoration means, and the like are prepared. When these items are selected, in processing step S11 of the screen output unit 10 in FIG. 13, the selection input of the item to be displayed on the screen is received and processed. Thereafter, in processing step S12 of the screen output unit 10 in FIG. 13, a display screen corresponding to the selected contents is displayed in the map pane 112 and the plan information pane 113.

In the map pane 112, the isolated operation plan and a map of a road, a house, or the like having a positional relationship corresponding thereto are displayed in a superimposed manner. The isolated operation plan is a system diagram colored so that each system can be identified, and on the system diagram, for example, switches in an open state and a closed state are color-coded to indicate a switch state in the system, and for example, the position of an accident point is displayed by a symbol such as a cross. On the map, for example, an area to which power is supplied by the isolated operation is colored and displayed.

The plan information pane 113 displays specific contents of the factor selected in the display content selection pane 111. The example in FIG. 14 shows an example in which the restoration work plan, the restoration time step of each switch section, and the information at the time of selecting the power restoration means are displayed in detail. It should be noted that the restoration work plan is a diagram showing work and movement performed by each worker or workgroup in each time period.

The screen output unit 10 preferably displays, for example, a button, a pull-down, or the like in a display content selection pane 111 (see FIG. 13) on the display device 11 described below. By depressing or selecting one or a plurality of buttons, pull-down, or the like displayed on the display device 11 by the operator, the screen output unit 10 outputs the display contents selected by the operator to another pane displayed on the display device 11.

On this occasion, the display contents that can be selected are, for example, the power supply area according to each of the isolated operation plans 1 and 2 prepared by the isolated operation planning unit 7, the switch state, the accident point information, the map of the roads, houses, and the like, the restoration work plan prepared by the restoration work planning unit 9, the restoration time step of each switch section, the restoration means, and the like.

The present invention is not limited to the embodiments described above, and includes various modifications. For example, the above-described embodiments are described in detail for easy understanding of the present invention, and are not necessarily limited to those including all the configurations described. Some of the configurations of a certain embodiment can be replaced with configurations of another embodiment, and the configurations of another embodiment can also be added to the configurations of the certain embodiment. In addition, it is also possible to add, delete, and replace another configuration with respect to some of the configurations of each of the embodiments.

Some or all of the above-described configurations, functions, processing units, processing means, and the like may be implemented by hardware such as an integrated circuit, for example. Each of the above-described configurations, functions, and the like may be implemented by software by a processor interpreting and executing a program for implementing each function. Information such as a program, a table, and a file for implementing each function can be stored in a recording device such as a memory, a hard disk, and a solid state drive (SSD), or a recording medium such as a flash memory card and a digital versatile disk (DVD).

In each embodiment, the control lines and the information lines indicate those which are considered necessary for the description, and do not necessarily indicate all the control lines and the information lines on the product. Actually, it can be considered that almost all configurations are connected to each other.

### REFERENCE SIGNS LIST

7 isolated operation planning unit
9 restoration work planning unit
10 screen output unit
11 display device
12 restoration decision-making assistance apparatus
13 input device
DB large-capacity storage unit
D1 system information
D11 switch number field
D12 adjacent switch number field
D13 load capacity field
D14 consumer number field
D15 distributed power source number field
D16 distributed power source capacity field
D17 voltage source presence/absence information field
D2 facility damage information
D21 facility damage number field
D22 switch number field
D23 facility damage type field
D3 power outage information
D31 switch number field
D32 power outage flag field
D4 essential load information
D41 consumer number field
D42 load capacity field
D43 importance degree field
D5 map information
D6 resource information
D61 resource type field
D62 resource count field
D7 isolated operation planning unit
D8 required work time information
D81 facility damage type field
D82 restoration required work time field
L power distribution system
110 screen
111 display content selection pane
112 map pane
113 plan information pane

1. A restoration decision-making assistance apparatus for connecting a power system section disconnected due to a power system accident to a power system again, the restoration decision-making assistance apparatus comprising:
an isolated operation planning unit configured to define a switch section divided by adjacent switches for the disconnected power system section, and to prepare an isolated operation plan with at least a switch section which includes a distributed power source therein or in which a power source vehicle is arranged as an isolated operation section; and
a restoration work planning unit configured to prepare a restoration work plan for a switch section in which an accident or a damaged facility is present in the power system.

2. The restoration decision-making assistance apparatus according to claim 1, wherein
the isolated operation planning unit prepares an isolated operation plan for presenting a switch section in which isolated operation is allowed to be performed after restoration work of an accident or damaged facility, and
the restoration work planning unit prepares a restoration work plan of an accident or damaged facility that minimizes power outage damage, a restoration time step of each switch section, and a power restoration means thereof based on the isolated operation plan.

3. The restoration decision-making assistance apparatus according to claim 1, wherein the isolated operation planning unit prepares a first isolated operation plan indicating a switch section in which an isolated operation is allowed to be performed immediately and a second isolated operation plan indicating a switch section in which an isolated operation is allowed to be performed after restoration work.

4. The restoration decision-making assistance apparatus according to claim 2, wherein the restoration work planning unit prepares a restoration work plan for an accident or a damaged facility that minimizes power outage damage based on the isolated operation plan.

5. The restoration decision-making assistance apparatus according to claim 2, wherein the restoration work planning unit prepares a restoration time step of each switch section and a power restoration means thereof based on the isolated operation plan.

6. The restoration decision-making assistance apparatus according to claim 4, wherein the restoration work planning unit prepares a restoration work plan by optimization calculation to minimize power outage damage.

7. The restoration decision-making assistance apparatus according to claim 1, further comprising a screen output unit configured to output an isolated operation plan prepared by the isolated operation planning unit and a restoration work plan prepared by the restoration work planning unit to a screen.

8. The restoration decision-making assistance apparatus according to claim 7, wherein the screen output unit outputs, to a screen, a first isolated operation plan indicating a switch section in which an isolated operation is allowed to be performed immediately prepared by the isolated operation planning unit, and a second isolated operation plan indicating a switch section in which an isolated operation is allowed to be performed after restoration work.

9. The restoration decision-making assistance apparatus according to claim 7, wherein the screen output unit outputs a restoration work plan prepared by the restoration work planning unit, a restoration time step of each switch section, and a power restoration means thereof to a screen.

10. The restoration decision-making assistance apparatus according to claim 9, wherein the screen output unit outputs a restoration work plan prepared by the restoration work planning unit to a screen.

11. The restoration decision-making assistance apparatus according to claim 9, wherein the screen output unit outputs a restoration time step of each switch section and a power restoration means thereof prepared by the restoration work planning unit to a screen.

12. A restoration decision-making assistance method that is implemented by using a computer and connects a power system section disconnected due to an accident of a power system to the power system again, the restoration decision-making assistance method comprising:
defining a switch section divided by adjacent switches for the disconnected power system section, and preparing an isolated operation plan with at least a switch section having a distributed power source therein or a switch section in which a power source vehicle is arranged as an isolated operation section; and
preparing a restoration work plan for a switch section in which an accident or damaged facility is present in the power system.

13. The restoration decision-making assistance method according to claim 12, wherein the isolated operation plan includes a first isolated operation plan indicating a switch section in which an isolated operation is allowed to be performed immediately and a second isolated operation plan indicating a switch section in which an isolated operation is allowed to be performed after restoration work, and a restoration work plan including a procedure and a resource in restoration work is prepared based on the second isolated operation plan.

14. The restoration decision-making assistance method according to claim 12, further comprising, according to the isolated operation plan, in consideration of a load capacity of a switch section in which power outage restoration is possible due to interconnection with an isolated operation and a power system or an isolated operation section, and a required time required for the switch section to be restored from power outage, preparing a restoration plan that minimizes a sum of a product of the load capacity and the required time for all switch sections.
